(19) United States
(12) Patent Application Publication
(10) Pub. No.: US 2013/0010711 A1
(43) Pub. Date: Jan. 10, 2013

(54) Random Access with Primary and Secondary Component Carrier Communications

(76) Inventors: Daniel Larsson, Solna (SE); Lisa Boström, Solna (SE); Dirk Gerstenberger, Stockholm (SE); Jung-Fu Cheng, Fremont, CA (US); Robert Baldemair, Solna (SE); Mattias Frenne, Uppsala (SE)

(21) Appl. No.: 13/502,309

(22) PCT Filed: Mar. 9, 2012
(86) PCT No.: PCT/SE2012/050265

§ 371 Date: Apr. 16, 2012

Related U.S. Application Data
(60) Provisional application No. 61/504,786, filed on Jul. 6, 2011.

(51) Int. Cl. H04W 74/08; H04W 52/04

(52) U.S. Cl. 370/329

(57) ABSTRACT

The invention relates to random access procedures in an LTE-system applying carrier aggregation, in particular to support network-initiated random access on secondary cells. A UE transmits a preamble on a random access channel to a radio base station on a secondary cell and receives or detects a random access response message from the base station including timing advance information for uplink transmission by the UE. The UE can determine the secondary cell that the control information in the random access response message refers to and transmits to the base station based on the timing advance information in the random access response message.

### TECHNICAL FIELD

The technology relates to radio communications, and in particular, to random access procedures for mobile radios.

### BACKGROUND

LTE-Advanced is an evolution of LTE that aims to increase data rates, bandwidth, VoIP capacity, and spectrum efficiency while also reducing user and control plane latency. To accomplish these advances, many new features and concepts have been introduced including heterogeneous cell overlays (e.g., relays), coordinated multi-point (CoMP), bandwidth/spectrum aggregation, MIMO enhancement, hybrid multiple access scheme for uplink communications, downlink and uplink inter-cell interference management, etc.

LTE uses OFDM in the downlink and DFT-spread OFDM in the uplink. The basic LTE downlink physical resource can thus be seen as a time-frequency grid as illustrated in FIG. 1, where each resource element corresponds to one OFDM subcarrier during one OFDM symbol interval.

In the time domain, LTE downlink transmissions are organized into radio frames of 10 ms, each radio frame consisting of ten equally-sized subframes of length T_{subframe}=1 ms.

Furthermore, the resource allocation in LTE is typically described in terms of resource blocks (RB), where a resource block corresponds to one slot (0.5 ms) in the time domain and 12 contiguous subcarriers in the frequency domain. A pair of two adjacent resource blocks in time direction (1.0 ms) is known as a resource block pair. Resource blocks are numbered in the frequency domain, starting with 0 from one end of the system bandwidth.

The notion of virtual resource blocks (VRB) and physical resource blocks (PRB) has been introduced in LTE. The actual resource allocation to a UE is made in terms of VRB pairs. There are two types of resource allocations, localized and distributed. In the localized resource allocation, a VRB pair is directly mapped to a PRB pair, hence two consecutive and localized VRB are also placed as consecutive PRBs in the frequency domain. On the other hand, the distributed VRBs are not mapped to consecutive PRBs in the frequency domain; thereby providing frequency diversity for data channel transmitted using these distributed VRBs.

Downlink transmissions are dynamically scheduled, i.e., in each subframe the base station transmits control information about to which terminals data is transmitted and upon which resource blocks the data is transmitted, in the current downlink subframe. This control signaling is typically transmitted in the first 1, 2, 3 or 4 OFDM symbols in each subframe, and the number n=1, 2, 3 or 4 is known as the Control Format Indicator (CFI). The downlink subframe also contains common reference symbols (CRS), which are known to the receiver and used for coherent demodulation of, e.g., the control information.

The LTE Rel-10 specifications support Component Carrier (CC) bandwidths up to 20 MHz (which is the maximum LTE Rel-8 carrier bandwidth). An LTE Rel-10 operation wider than 20 MHz is possible using Carrier Aggregation (CA) which appears as a number of LTE carriers to an LTE Rel-10 terminal. For early LTE Rel-10 deployments, there will be a smaller number of LTE Rel-10-capable terminals compared to many LTE legacy terminals. Therefore, it is desirable to efficiently use a wide carrier in such a way that legacy terminals can be scheduled in all parts of the wideband LTE Rel-10 carrier. With Carrier Aggregation (CA), an LTE Rel-10 terminal can receive multiple CCs, where the CC has, or at least has the possibility to have, the same structure as a legacy Rel-8 carrier.

The LTE Rel-10 standard supports up to 5 aggregated carriers where each carrier is limited to one of six bandwidths: 6, 15, 25, 50, 75, or 100 resource blocks (RBs) corresponding to 1.4, 3, 5, 10, 15, and 20 MHz, respectively.

The number of aggregated CCs as well as the bandwidth of an individual CC may be different for uplink and downlink transmissions. A symmetric configuration refers to the case where the number of CCs in downlink and uplink is the same, whereas an asymmetric configuration refers to the case that the number of CCs is different. The number of CCs configured in the network may differ from the number of CCs seen by a terminal. A terminal may, for example, support more downlink CCs than uplink CCs, even though the network offers the same number of uplink and downlink CCs.

In LTE-10 and 11, the concept of a carrier aggregation “cell” is introduced which is an extension of the traditional understanding of a geographic coverage cell. A carrier aggregation cell, from a UE's perspective, is a combination of downlink (DL) and optionally uplink (UL) radio resources available for possible use by UEs that are in range. As one example, a carrier aggregation cell 0 includes a DL component carrier DL CC0 linked to an UL CC0. The linking between the carrier frequency of the DL radio resources and the carrier frequency of the UL radio resources is indicated in system information transmitted on the DL radio resources DL CC0 and is referred to in LTE-11 as SIB2 linkage. CC cells can be co-located and overlaid providing nearly the same coverage, be co-located but providing different coverage, provide macro coverage on one cell and hot spot coverage inside the macro cell using remote radio head coverage, and provide frequency selective repeater coverage.

During initial or random access (RA) to the radio network, an LTE Rel-10 UE terminal behaves similarly to a LTE Rel-8 terminal. Upon successful connection to the network, a UE terminal may—depending on its own capabilities and the network—be configured with additional CCs in the UL and DL. CC configuration is based on radio resource control (RRC). Due to typically heavy RRC signaling and its relatively slow speed, a UE terminal may be configured with multiple CCs on which the UE may be scheduled to receive information on the physical DL shared channel (PDSCH), i.e., the UE-specific DL active CC set, and on which the UE may be scheduled to transmit information on the physical UL shared channel (PUSCH). Even though not all of those configured CCs are currently used for or by the UE, a UE terminal being activated on multiple CCs must monitor all DL CCs for the Physical Downlink Control Channel (PDCCH) and the PDSCH. This requires increased receiver bandwidth and higher sampling rates resulting in higher power consumption.

In order to preserve orthogonality in the uplink (UL), the UL transmissions from multiple UEs need to be time-aligned at the base station (an eNodeB in LTE). Since UEs may be located at different distances from the base station (see FIG. 1), the UEs must initiate their UL transmissions at different times to be received time-aligned at the base station. A UE far from the base station needs to start transmission earlier than a UE close to the base station. This can for example be handled by a timing advance (TA) of the UL transmissions where a UE starts its UL transmission before a nominal time given by the timing of the DL signal received by the UE. This TA concept is illustrated in FIG. 2.

The UL timing advance is maintained by the base station through timing advance commands to the UE based on measurements on UL transmissions from that UE. In other words, the timing advance commands inform the UE to start its UL transmissions earlier or later. This applies to all UL transmissions except for random access preamble transmissions. There is a strict relationship in LTE between a DL transmission and a corresponding UL transmission. Examples include: (1) the timing between a DL-SCH transmission on the PDSCH to the HARQ ACK/NACK feedback transmitted in UL (either on the PUCCH or the PUSCH), and (2) the timing between an UL grant transmission on the PDCCH to the UL-SCH transmission on the PUSCH.

Increasing the timing advance value for a UE decreases the UE processing time between the DL transmission and the corresponding UL transmission. For this reason, an upper limit on the maximum timing advance has been defined by 3GPP in order to set a lower limit on the processing time available for a UE. For LTE, this upper limit TA value is currently set to roughly 667 us, which corresponds to a cell range of 100 km (note that the TA value compensates for the round trip delay).

LTE Rel-10 introduces a “primary” cell (PCell), which is the set of UL CC on which all control signalling is transmitted to/from a UE together with the linked DL CC. A cell configured for the UE that is not the PCell is called a “secondary” cell (SCell). A UE can have up to four SCell's in LTE Rel-10 and can be added, removed, or reconfigured for the UE at any time by the base station. For an activated SCell, the UE monitors the PDCCH control information that schedules the PDSCH on that SCell. However, there is only a single timing advance value per UE in LTE Rel-10, and all UL cells including the PCell and all activated SCells are assumed to have the same transmission timing. The reference point for the timing advance is the received timing of the primary DL cell. In LTE Rel-11, the UL SCells sharing the same TA value (for example depending on the deployment) are configured by the network to belong to a “TA group.” If at least one UL SCell of the TA group is time aligned, all SCells belonging to the same group may use this TA value. To obtain time alignment for an SCell belonging to a different TA group than the PCell, a current 3GPP assumption is that a network-initiated random access may be used to obtain an initial TA for this SCell and for the TA group that the SCell belongs to.

In random access procedures, even though a UE does not have a dedicated UL resource to transmit on, the UE may transmit a signal to the base station on a special resource reserved for random access: a physical random access channel (PRACH). This channel can for instance be limited in time and/or frequency as in LTE. The resources available for PRACH transmissions are provided to UEs as part of broadcast system information or as part of dedicated RRC signaling in case of handover. In LTE, the random access procedure can be used for a number of different reasons such as: initial access (for UEs in the LTE IDLE or LTE DETACHED states), incoming handover, resynchronization of the UL, scheduling request (for a UE that is not allocated any other resource for contacting the base station), and positioning.

A contention-based random access (RA) procedure used in LTE is illustrated in FIG. 3. The UE starts the random access procedure by randomly selecting one of the predetermined random access preambles available for contention-based random access. The UE then transmits the selected random access request message which includes a RA preamble on the physical random access channel (PRACH) to a base station in the radio access network (RAN). The base station acknowledges any RA preamble it detects by transmitting a random access response message (referred to as MSG2 in LTE) including an initial grant to be used on the uplink shared channel, a Temporary C-Radio Network Temporary Identifier (TC-RNTI), and a time advance (TA) update based on the timing offset of the RA preamble measured by the base station on the PRACH. When the MSG2 is transmitted to the UE over the PDCCH, the PDCCH message CRC bits are scrambled with a Random Access-Radio Network Temporary Identifier (RA-RNTI).

When receiving the RA response (MSG2), the UE uses the initial grant to transmit a scheduled UL message (referred to as MSG3 in LTE) that in part is used to trigger the establishment of radio resource control (RRC) and in part to uniquely identify the UE on the common channels of the cell. Among other, the UE includes its C-RNTI or, if the UE has not yet assigned a C-RNTI, a core-network terminal identifier into the MSG3. The timing advance command provided in the random access response (MSG2) is applied by the UE when it sends its UL transmission of MSG3. The base station can change the radio resources blocks assigned for a MSG3 re-transmission by sending an UL grant whose CRC bits are scrambled with the TC-RNTI.

The RA procedure ends with the base station solving any preamble contention that may have occurred if multiple UEs transmitted the same preamble at the same time. This can occur since each UE randomly selects when to transmit and which preamble to use. If multiple UEs select the same preamble for the transmission on the RACH, there will be contention between these UEs that needs to be resolved through the contention resolution message (referred to as MSG4 in LTE). An example where contention occurs is illustrated in FIG. 4, with two UEs transmitting the same preamble, p₅, at the same time. A third UE also transmits at the same RACH, but since it transmits with a different preamble, p₁, there is no contention between this UE and the other two UEs. The base station sends the contention resolution message (MSG4) with its PDCCH CRC scrambled with the C-RNTI if the UE previously has a C-RNTI assigned. If the UE does not have a C-RNTI previously assigned, the PDCCH CRC is scrambled with the TC-RNTI.

The UE can also perform contention-free random access. A contention-free random access can be initiated by the base station to get the UE to achieve synchronization in the uplink. The base station initiates a contention-free random access either by sending a PDCCH order to perform a contention-free random access or indicating it in an RRC message. The later of the two is used in case of handover. An example procedure for the UE to perform contention free random access is illustrated in FIG. 5. Similar to contention-based random access in LTE, MSG2 is transmitted in the DL to the UE and its corresponding PDCCH message CRC is scrambled with the RA-RNTI. The UE considers the contention resolution successfully completed after it has successfully received MSG2. Nonetheless, the UE still sends MSG3. For contention-free and contention-based random access, MSG2 contains a timing advance value that enables the eNB to set the initial/updated timing according to the UE's transmitted preamble.

In LTE Rel-10, the RA response message MSG2 is sent on the DL component carrier that is “SIB2 linked” to the UL component carrier on which the UE sent the random access request preamble. SIB2 linking is a cell-specific linking between one DL carrier and UL carrier that is broadcasted as part of System Information in System Information Block 2 (SIB2). Again, the term “cell” refers to either a primary or secondary serving cell as described above. Since RA in Rel-10 is restricted to UL PCell, MSG2 is always transmitted on the DL PCell.

FIG. 6A gives a simple example where remote radio heads 12 and 14 are coupled to a base station (BS) 10, and UE 16 is closer to remote radio head 12 corresponding to antenna cell 1 than to remote radio head 14 corresponding to antenna cell 2. As a result, the timing advance TA 1 for the UE's uplink transmissions in cell 1 is smaller than the timing advance TA 2 for the UE's uplink transmissions in cell 2. Corresponding FIG. 6B shows the UE timing advances for cells 1 and 2 where transmit timing t₁ for cell 2 is earlier than t₀ for cell 1.

In LTE Rel-10, the random access procedure is limited to the primary cell (PCell), meaning that the UE can only send a RA request preamble on the primary cell and that the RA response (MSG2) and the UE's first scheduled UL transmission (MSG3) are only received and transmitted on the primary cell. MSG4 can, in Rel-10, be transmitted on any DL cell. In LTE Rel-11, the random access procedure may also be supported on secondary cells (SCells), at least for UEs supporting Rel-11 carrier aggregation; however, in this case only network-initiated random access on secondary cells (SCells) is assumed, meaning that UEs cannot initiate RA on an SCell. The only possibility for the UE to perform random access on an SCell is if the base station ordered the UE to perform the random access, i.e. it is not possible for the UE to initiate a random access by its own on an SCell.

### SUMMARY

If the RA request is only allowed on the primary UL cell, then the RA response message (e.g., MSG2 in LTE) is only sent on the primary DL cell. Because the primary cell is UE-specific assigned, different UEs may have different primary cells. There is thus no mechanism to set a different timing for a secondary cell than for the PCell.

A first aspect of embodiments of the present invention relates to a UE performing a RA on the secondary cell (RA on the SCell) after completing a RA request-response exchange on the primary cell, where the RA response to the SCell includes timing advance information for the SCell and preferably a pointer or other means to identify the SCell. The UE then uses that SCell timing advance information to properly time its uplink transmission on the SCell. This signalling exchange is illustrated in an example in FIG. 7.

It is an advantage of embodiments of the present invention that the UE can perform random access on a secondary cell and the base station can send the UE a RA response that includes SCell timing advance (TA) and preferably also a SCell identifier. This is a more direct process that allows the UE to more efficiently and effectively synchronize to the SCell and be able to transmit over the SCell using the proper timing advance for the SCell where the base station only needs to identify the correct cell/component carrier in the RA response message, which saves overhead for the random access procedure.

A second aspect of embodiments of the present invention relates to a UE switching some if its allocated blind decoding resources (“blind decodes”) from a UE-specific search space to another search space where it can receive messages addressed to this other search space, e.g. related to a random access procedure where the UE sent a RA preamble on a particular secondary cell.

It is a further advantage of embodiments of the present invention that the UE can perform random access on a secondary cell without an increase in blind decodes. As a result, the same UE platform may be re-used for UEs that do not support random access on secondary cells as well as UEs that can perform random access on a secondary cell. Allowing the UE to perform random access on a secondary cell instead of the primary cell reduces congestion on the primary cell's control channel (e.g., PDCCH).

A third aspect of embodiments of the present invention relates to random access transmit power levels whereby the UE transmits to the base station on a group of secondary cells that is defined to be in the same timing alignment group and applying a transmit power level that is set considering the power used to transmit the preamble. This signalling exchange is illustrated in an example in FIG. 18.

It is yet another advantage of embodiments of the present invention that the initial transmit power level for an UL transmission on a secondary cell is set more accurately which leads to higher initial throughput and therefore better performance. It also means less interference caused towards other UEs in the network which improves system performance.

### BRIEF DESCRIPTION OF THE DRAWINGS

FIG. 1 illustrates a cell with two UEs at different distance from a BS.

FIG. 2 illustrates an example of timing advance of UL transmissions depending on distance to a BS.

FIG. 3 is a signaling diagram for contention-based random access procedure in LTE.

FIG. 4 illustrates contention based random access, where there is contention between two UEs.

FIG. 5 is a signaling diagram for contention-free random access procedure in LTE.

FIG. 6A shows an example of a component carrier cell configuration using remote radio heads in two cells.

FIG. 6B shows example timing differences for the two cells in FIG. 6A.

FIG. 7 is a non-limiting, example signaling diagram in accordance with a first non-limiting example embodiment.

FIGS. 8A and 8B are non-limiting, example flowchart diagrams for a UE and a BS that may be used to implement the signaling diagram of FIG. 7.

FIG. 9 illustrates an example of common and UE-specific search spaces;

FIGS. 10A and 10B illustrate flowchart diagrams for UE and BS of a first example of the first embodiment.

FIGS. 11A and 11B illustrate flowchart diagrams for UE and BS of a second example of the first embodiment.

FIG. 12 is a non-limiting example signaling diagram in accordance with a second non-limiting example embodiment.

FIG. 13 illustrates a flowchart diagram for a UE of a first example of the second embodiment.

FIG. 14 illustrates a flowchart diagram for a UE of a second example of the second embodiment.

FIGS. 15A and 15B are non-limiting example flowchart diagrams for a UE and base station (BS) involved in a contention-based random access procedure involving a PCell and an SCell.

FIG. 16 illustrates an example signalling diagram between a UE and BS showing a random access procedure where the UE sends the RA request on the SCell using a reserved one of the SCell RA preambles.

FIG. 17 illustrates an example flowchart diagrams for a UE receiving from the network different RA configurations for PCell and SCell.

FIG. 18 is a non-limiting, example signaling diagram in accordance with a third non-limiting example embodiment.

FIGS. 19A, 19B, and 19C are non-limiting example flowchart diagrams for a BS in accordance with the third example embodiment.

FIG. 20 is a non-limiting, example function block diagram of a UE.

FIG. 21 is a non-limiting, example function block diagram of a BS.

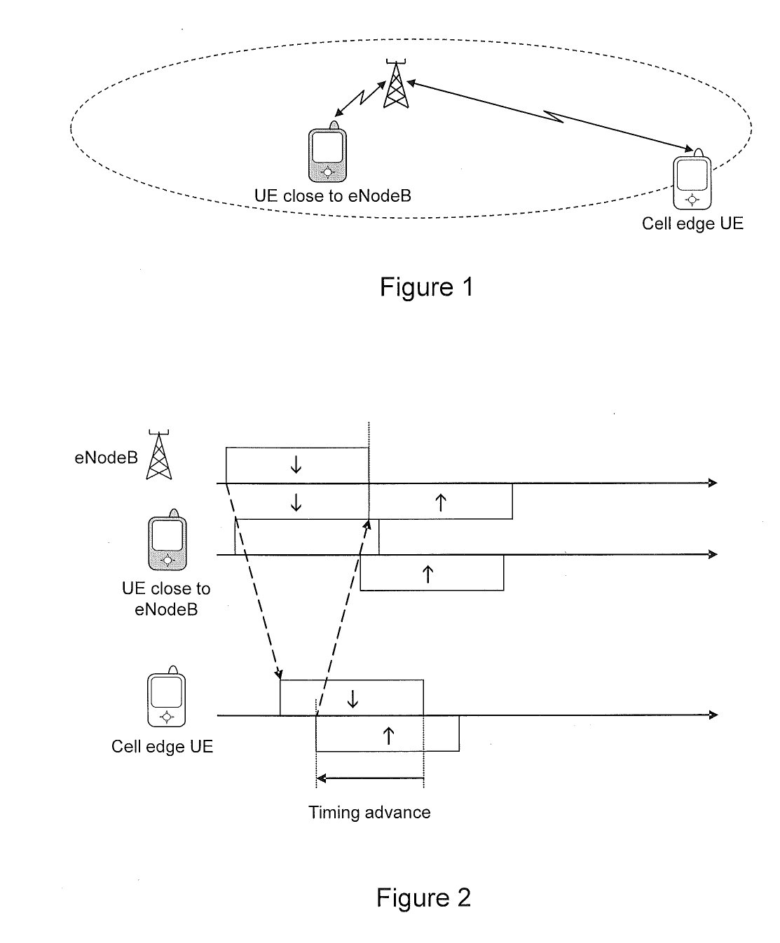

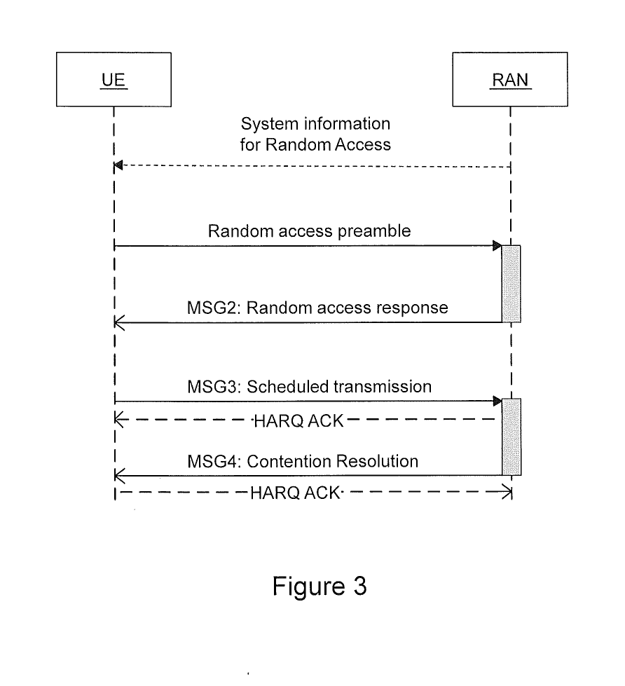

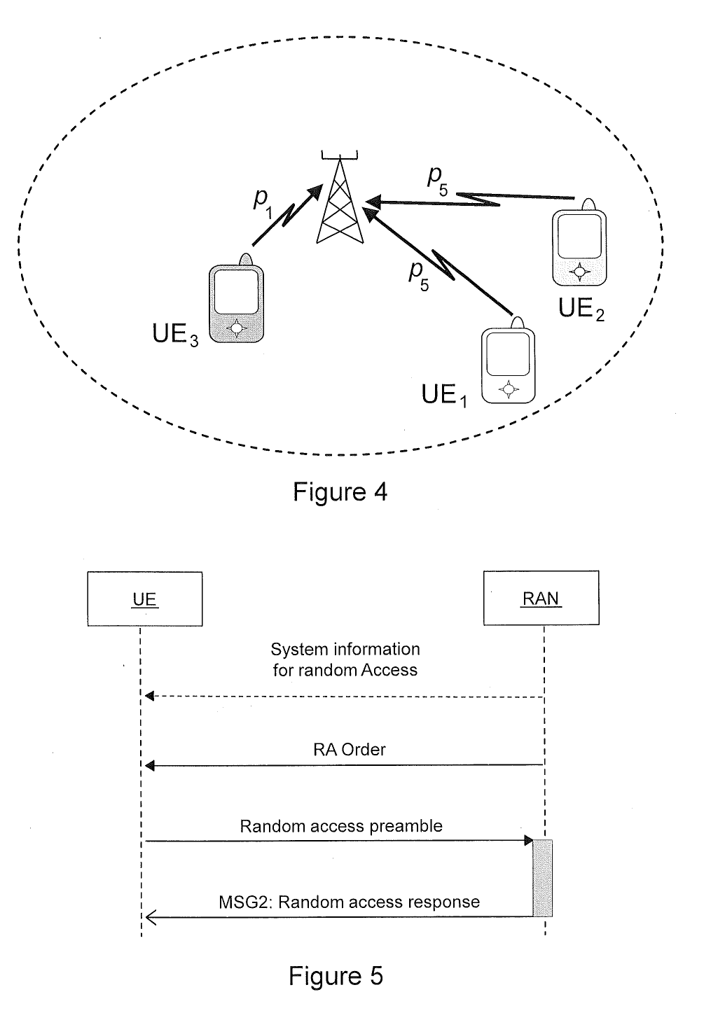

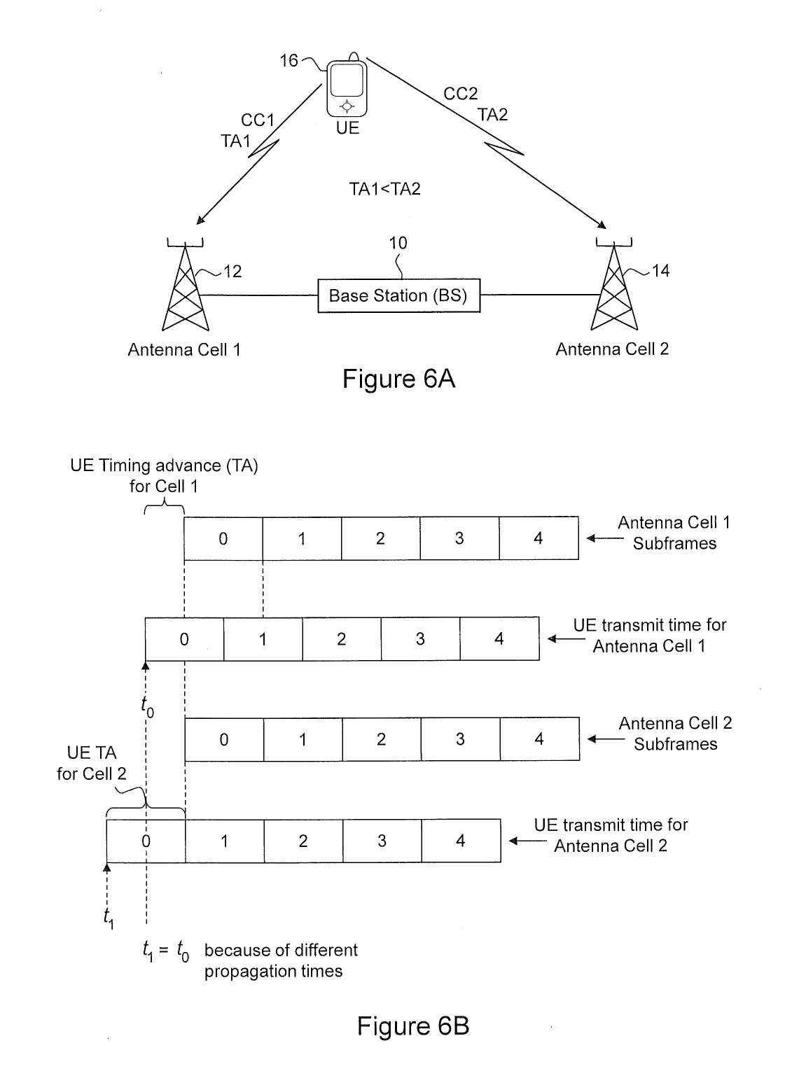

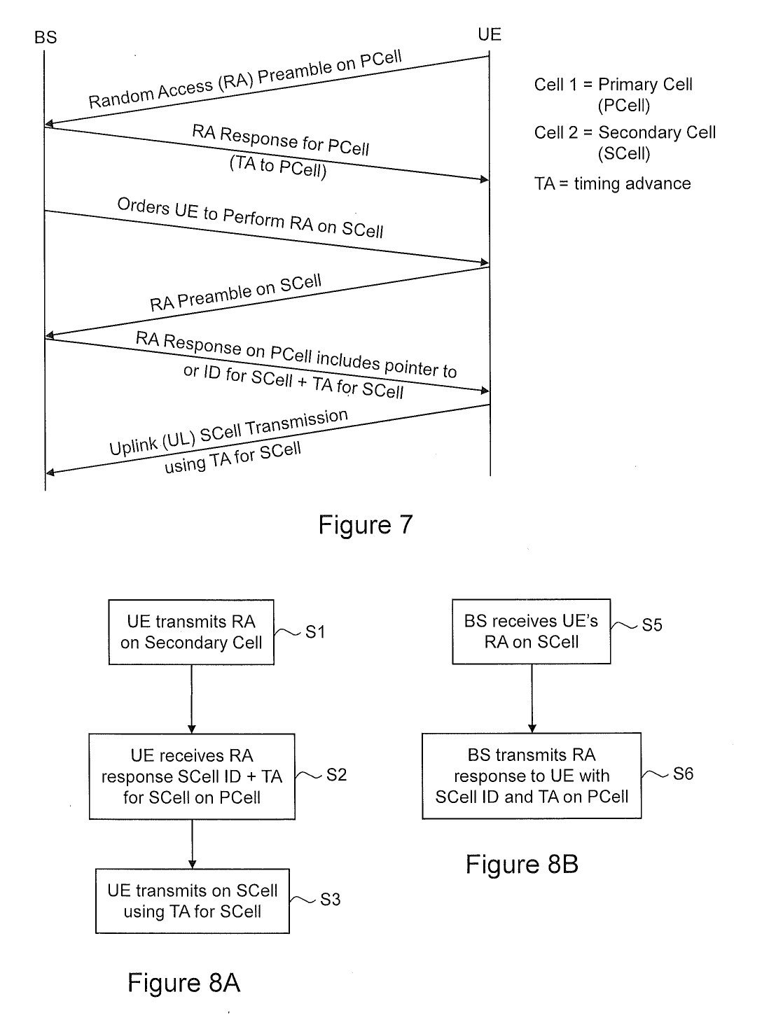

### DETAILED DESCRIPTION

The following description sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, the technology can additionally be considered to be embodied entirely within any form of non-transitory computer-readable memory, such as solid-state memory, magnetic disk, or optical disk containing an appropriate set of computer instructions that would cause a processor to carry out the techniques described herein.

Thus, for example, it will be appreciated by those skilled in the art that diagrams herein can represent conceptual views of illustrative circuitry or other functional units. Similarly, it will be appreciated that any flow charts, state transition diagrams, pseudocode, and the like represent various processes which may be substantially represented in computer readable medium and so executed by a computer or processor, whether or not such computer or processor is explicitly shown. The functions of the various illustrated elements may be provided through the use of hardware such as circuit hardware and/or hardware capable of executing software in the form of coded instructions stored on computer-readable medium. Thus, such functions and illustrated functional blocks are to be understood as being either hardware-implemented and/or computer-implemented, and thus machine-implemented. Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Although some of the initial description and identification of problems below is in the context of an LTE-based system, the technology in this application can be applied to any radio communications system and/or network where user equipment (UE) communicates over a radio interface with a radio base station using a random access procedure.

A first embodiment of the present invention is illustrated by help of FIG. 8A, which is a flowchart showing example procedures of a UE, and FIG. 8B, which is a flowchart showing example procedures of an associated base station (BS). In step S1, the UE transmits a RA request on a secondary cell, e.g., in response to a command or order from the base station. The base station receives the UE's RA request (step S5), and transmits to the UE a RA response that includes an SCell timing advance (TA) and preferably also an SCell identifier (steps S2 and S6). The UE transmits over the SCell using that TA for the SCell (step S3).

The SCell identifier may identify on which secondary cell the UE's RA preamble was detected and can be a cell index. Examples include but are not limited to SCellIndex, ServCellIndex, or CIF, E-UTRA Channel Number (EARCFN), or an index which corresponds to a subset of EARCFN values. The SCell timing advance information also may include a timing advance (TA) group identifier of the group to which the SCell the detected RA preamble belongs.

The following example embodiments take into account UE decoding operations and resources. In an example LTE system, after channel coding, scrambling, modulation and interleaving of the control information in LTE, the modulated control information symbols are mapped to radio resource elements (REs) in the DL subframe control region. To multiplex multiple control channels (PDCCHs) onto the control region, LTE defines control channel elements (CCEs), where each CCE maps to 36 resource elements (REs). One PDCCH can, depending on the information payload size and the required level of channel coding protection, include 1, 2, 4, or 8 CCEs. The number of CCEs is referred to as the CCE aggregation level (AL). Link-adaptation of the PDCCH is obtained by choosing the aggregation level. In total, there are N_{CCE} CCEs available for all PDCCHs to be transmitted in the subframe, and the number N_{CCE} varies from subframe to subframe depending on the number of control symbols n.

As the total amount of candidates is greater than the amount of scheduling assignments and UL grants that the UE can be allocated per subframe, the UE needs to “blindly” decode, whether any of the PDCCH candidates are corresponding actual scheduling assignments or UL grants. In addition, assuming a reasonable number of “blindly” decodes, the total number of candidates on a per cell basis can be too many for the UE to compute. As a result, some restrictions are placed on the number of possible blind decodes a UE terminal needs to perform. For instance, the CCEs are numbered, and CCE aggregation levels of size K can only start on CCE numbers evenly divisible by K (e.g. mod(N,K)=0)

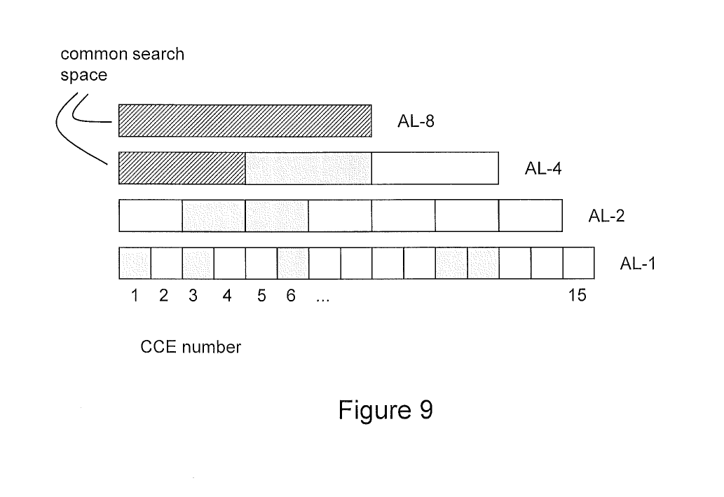

The sets of CCEs that a UE terminal must blindly decode and search for a valid PDCCH are called “search spaces” in LTE. In other words, this is the set of CCEs on an AL that a UE must monitor for scheduling assignments or other control information. FIG. 9 shows an example of a search space that the UE must monitor. In each subframe and on each AL, a UE attempts to decode all the PDCCHs that can be formed from the CCEs in its search space. If the CRC checks as valid, then the content of the PDCCH is assumed to be valid for the UE, and it further processes the received information. Often two or more UE terminals have overlapping search spaces, and the network has to select one of them for scheduling of the control channel. When this happens, the non-scheduled terminal is “blocked.” The search space varies pseudo-randomly from subframe to subframe to minimize this blocking probability.

LTE further divides a search space to a common search space and a UE-specific search space. In the common search space, the control channel (PDCCH) that contains information for all or a group of UE terminals is transmitted (paging, system information, etc). If carrier aggregation is used, a UE terminal finds the common search space present on the primary component carrier (PCC) only. The common search space is restricted to aggregation levels 4 and 8 to give sufficient channel code protection for all UE terminals in the cell (since it is a broadcast channel, only high AL are of interest since even cell-edge UEs must be reached). The 2 and 4 first PDCCH candidates (with the lowest CCE number) in an AL of 8 or 4, respectively, belong to the common search space. For efficient use of the CCEs, the remaining search space is UE-specific at each aggregation level.

A CCE includes 36 QPSK modulated symbols that map to the 36 resource elements (REs) unique for this CCE. To increase diversity and interference randomization, interleaving of all the CCEs is used before a cell-specific cyclic shift and mapping to REs as illustrated in the example processing steps of all the PDCCHs to be transmitted in a subframe. In most cases, some CCEs are empty due to the PDCCH location restriction to terminal search spaces and aggregation levels. The empty CCEs are included in the interleaving process and mapped to REs as any other PDCCH to maintain the search space structure. Empty CCEs are set to zero power. This power can instead be used by non-empty CCEs to further enhance the PDCCH transmission, Furthermore, to enable the use of 4 antenna TX diversity, a group of 4 adjacent QPSK symbols in a CCE is mapped to 4 adjacent REs, denoted a RE group (REG). Hence, the CCE interleaving is quadruplex (group of 4) based and the mapping process has a granularity of 1 REG and one CCE corresponds to 9 REGs (=36 REs). There may be a collection of “leftover” REGs after the set of size N_{CCE} CCEs is determined (although the number of leftover REGs is always fewer than 36 REs) since the number of REGs available for PDCCH in the system bandwidth is typically not a multiple of 9 REGs. These leftover REGs are unused by the LTE system.

An LTE UE monitors the common search space on the primary cell and a UE-specific search space for each of its aggregated DL/UL cells. The common search space requires 12 blind decodes, and each UE-specific search space requires either 32 or 48 blind decodes, depending on whether the UE supports UL MIMO on the aggregated UL cell.

The UE monitors the following RNTIs associated with the random access procedure for each associated search space on the PDCCH; The RA-RNTI for the RA response message (e.g., MSG2) is monitored in the common search space on the primary cell. This is for the UE to be able to receive the random access response message, i.e. MSG2. The TC-RNTI, e.g., for MSG3, is monitored in the common search space on the primary cell for reallocating the MSG3 in frequency. The TC-RNTI for MSG4 is monitored in the common search space and UE specific TC-RNTI search space on the primary cell. The C-RNTI for MSG4 is monitored in the common search space on the primary cell and in the UE-specific C-RNTI search space on any serving PCell or SCell.

As explained above, one way to set the initial timing of a secondary cell is for the UE to send a RA preamble on that secondary cell, or alternatively, on another secondary cell that shares the same timing. But to do this, the UE must monitor the RA-RNTI in the common search space of each aggregated secondary cell. In the LTE example, this means the UE must perform 12 additional blind decodes for each secondary cell where it monitors the common search space. In addition to reducing blind decoding processing that UEs must perform, it would also be advantageous to allow the possibility of reusing LTE Rel-10 UE platforms for LTE Rel-11, which means keeping the maximum number of blind decodes for the UE at the same level as in Rel-10 in Rel-11.

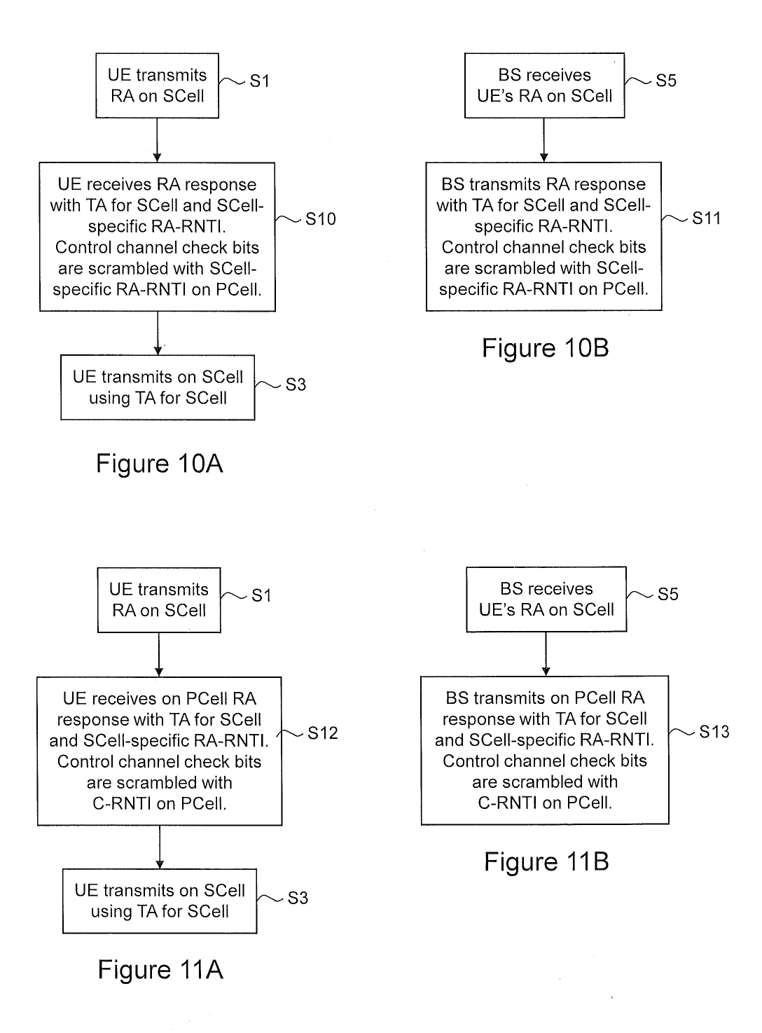

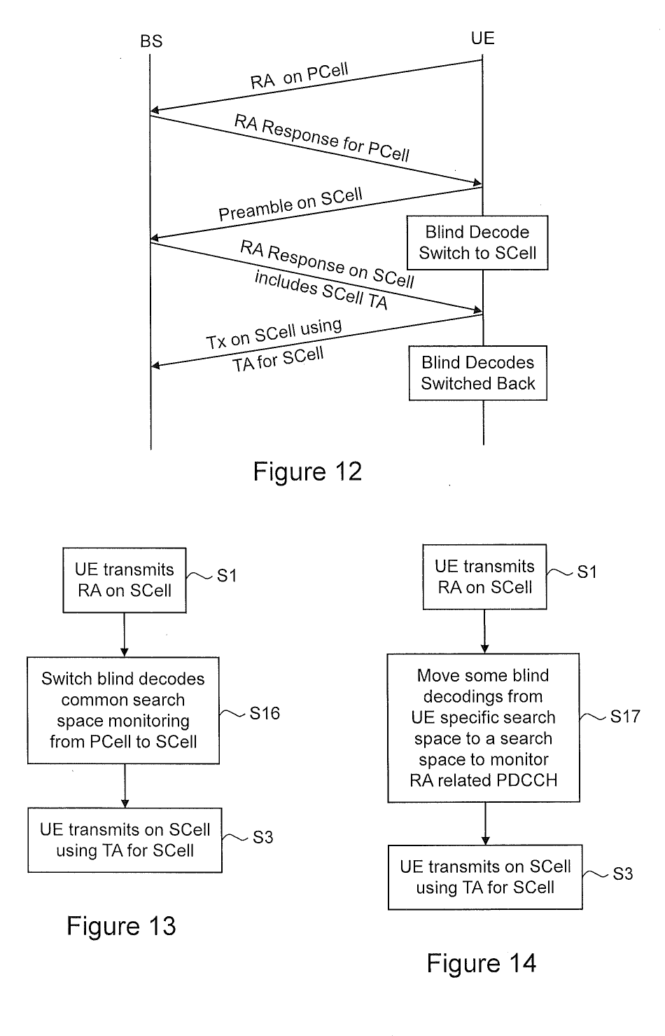

FIGS. 10-12 illustrate three examples according to the first embodiment of the present invention to provide an initial timing of a secondary cell to a UE whereby FIGS. 10A, 11A, and 12A illustrate the example procedures of the UE and FIGS. 10B, 11B, and 12B illustrate the example procedures of an associated base station. In step S1, the UE transmits a RA request on a secondary cell, e.g., in response to a command or order from the base station sent. The base station receives the UE's RA request (step S5) and transmits to the UE a RA response. According to one example embodiment (FIG. 10A, 10B), each SCell on which the UE has sent a preamble corresponds to a different RA-RNTI that the UE monitors. In steps S11 and S10, respectively, the base station transmits and the UE receives on the PCell a RA response that includes an SCell timing advance (TA) and an SCell-specific RA-RNTI (the RA-RNTI can be implicitly included, e.g. as scrambling mask in the PDCCH CRC). The RA-RNTI identifies the SCell on which the UE sent the RA request preamble and scrambles channel error check bits, e.g., PDCCH CRC bits. According to another example embodiment (FIG. 11A, 11B), if the UE sends a preamble on a SCell, the UE will receive MSG2 identified by its C-RNTI. The base station transmits and the UE receives on a RA response that includes a SCell tuning advance (TA) and a C-RNTI. The C-RNTI identifies the individual UE that has sent the RA request preamble and scrambles channel error check bits, e.g., PDCCH CRC bits. According to a second embodiment of the present invention, the UE switches some if its allocated blind decoding resources (“blind decodes”) from a UE-specific search space to another search space where it can receive messages related to a random access procedure where the UE sent a RA preamble on a particular secondary cell. The signalling diagram in FIG. 12 illustrates a PCell RA exchange between a UE and base station followed by the UE transmitting a RA request preamble on an SCell. Thereafter, the UE switches some or all of its currently allocated blind decode operations from the PCell common search space to that SCell common search space where the UE sent its RA SCell preamble. This means, it reallocates its processing of the blind decodes from a set of candidates on one cell or a specific area of one cell to another cell or specific area on the same cell.

The base station sends its RA response on the SCell to the UE, and then the UE transmits at the scheduled time using the received TA information and SCell ID. Thereafter, the UE switches the blind decodes back from the SCell common search space to the PCell common search space. The total number of blind decodes remains the same as the UE only looks at a different set of candidates.

FIGS. 14-17 illustrate by means of flowcharts showing UE procedures four examples according to the second embodiment of the present invention to provide an initial timing of a secondary cell to a UE. In step S1, the UE transmits a RA request on a secondary cell, e.g., in response to a command or order from the base station. According to a first example (FIG. 13), the UE switches some or all of its currently allocated blind decode operations from the PCell common search space to the SCell common search space (step 16). According to a second example (FIG. 14), the UE switches some or all of its currently allocated blind decode operations from a UE-specific PCell/SCell search space to a SCell search space where the UE while receive the related PDCCH messages to the RA SCell preamble (step 17). If the UE performs a contention-free random access, it stops monitoring this SCell search space when receiving the RA response from the base station and switches blind decoding to a where they where switched from If the UE performs a contention-based random access, it stops monitoring the specific search space for SCell when receiving a RA contention resolution message (e.g., MSG4) and then switches back its blind decodes to the original search space on where they were borrowed from, i.e. either on the PCell or SCell. The related PDCCH messages to the RA SCell preamble are mainly MSG2, MSG3 and MSG4. These PDCCH messages are identified by that there CRC is scrambled with the RA-RNTI, TC-RNTI for that UE or C-RNTI for that UE.

A further aspect of the present invention relating to contention-based random access on a secondary cell concerns that a base station cannot distinguish whether a legacy UE or a new UE is performing the random access. In LTE, legacy UEs (i.e. Rel.10 UEs) only monitor the RA-RNTI for the random access response message in a common search on the SIB2 linked DL cell or PCell. One solution proposed by the inventors to this second problem is for an advanced UE (i.e. a UE according to Rel.11 or later) to use a reserved set of random access preambles for contention-based random access on a secondary cell.

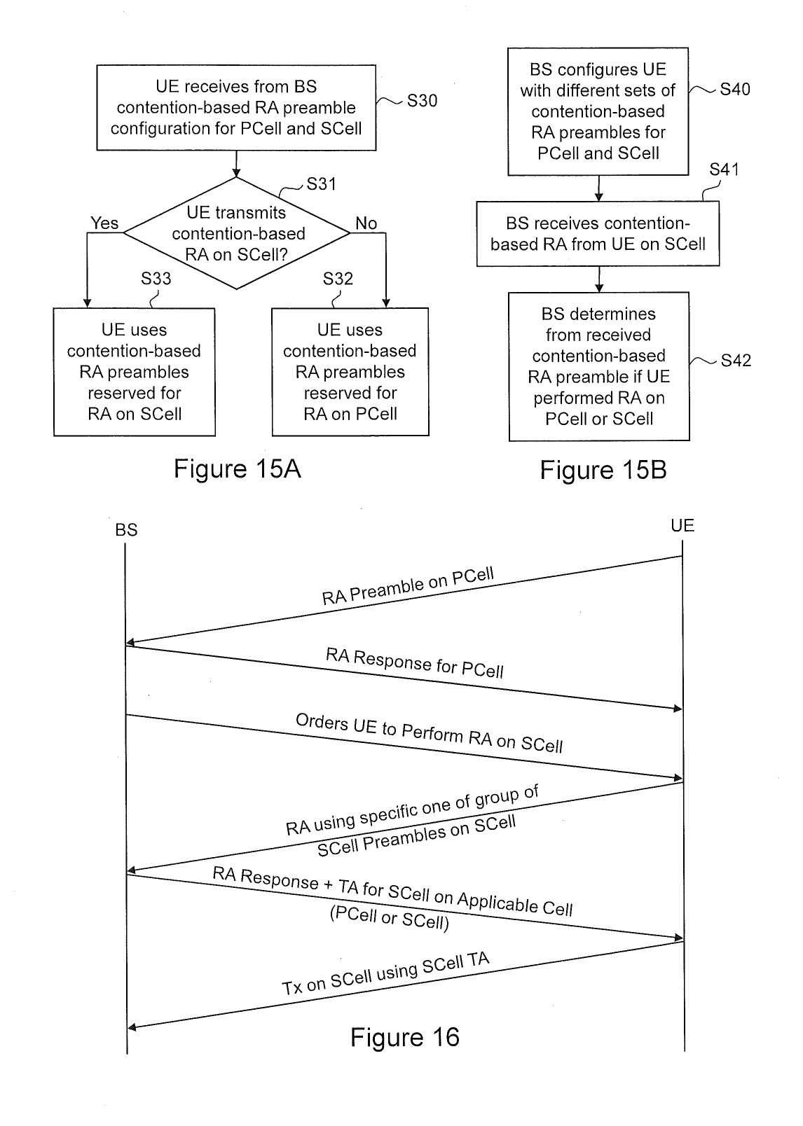

Thus, according to a further embodiment of the present invention, a UE uses a reserved set of random access preambles for contention-based random access on a secondary cell. This allows the receiving base station to detect that the random access is associated with a UE currently accessing the radio network on a secondary cell rather than a primary cell. FIGS. 15A and 15B are non-limiting example flowchart diagrams for a UE and base station (BS) involved in a contention-based random access procedure involving a PCell and an SCell. The base station configures the UE with different sets of contention-based RA preambles for the PCell and SCell (step S40). The UE receives the contention-based RA preamble configurations (step S30) and determines whether a contention-based RA request transmission is to be sent on the SCell (step S31). If not, the UE uses one of the contention-based RA preambles configured for RA on the PCell (step S32). If so, the UE uses one of the contention-based RA preambles configured on the SCell (step S33). In either case, the base station receives a contention-based RA request from the UE on a primary cell or a secondary cell using one of the contention-based RA preambles (step S41), and determines from the received RA preamble whether it belongs to the PCell set or the SCell set (step S42). If RA preamble is one of the SCell contention-based RA preambles, the base station knows that the UE currently accessing the radio network on a secondary cell rather than a primary cell.

FIG. 16 illustrates an example signalling diagram between the UE and base station showing a random access procedure where the UE sends the RA request on the SCell using a reserved one of the SCell RA preambles. The RA response with the timing advance for the SCell may be sent to the UE on the PCell or SCell.

A base station may provide or indicate to the UE one or several additional root sequences that the UE may use to generate the reserved RA preambles.

A base station may provide or indicate a set of reserved RA preambles within the set of RA preambles that are used for contention-free random access on a primary cell for legacy UEs. The base station or other radio network node knows which preambles within the contention-free random access set are used for random access on a secondary cell, and hence, it avoids assigning such preambles for contention-free random access for primary cells.

A base station may configure individual UEs with a specific set of RA preambles that the UE should use for a contention-free random access on a secondary cell. Because the base station will not know which cell is the primary cell for a particular UE when the eNB detects the preamble on a secondary cell, the base station configures separate sets of contention-free RA preambles on each secondary cell it operates. All UEs sharing the same primary cell and configured on a specific secondary cell are configured with the same set of contention-free RA preambles on this specific secondary cell. In this way, the base station can derive from the detected contention-free RA preamble the primary cell and transmit the RA response on the primary cell that includes the necessary secondary cell identification and timing advance information.

A base station may generate a RA response on the linked cell (primary or secondary) over which the UE made the random access request. The base station also sends a RA response on the primary cell for every attached UE that supports multiple timing advances (TAs). Because the primary cell can be different for different UEs, the base station includes information in RA response indicating to which primary cell it refers, similar to the embodiments described above. The base station may receive a RA request on a primary cell or secondary cell and transmits a RA response message in that cell and on the PCells of all UEs attached to that base station.

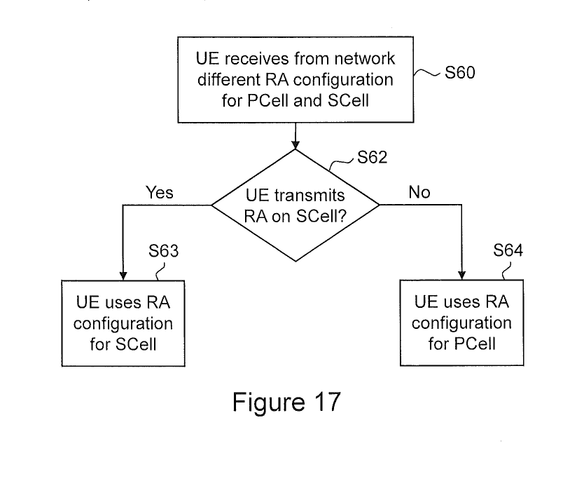

A base station may signal a separate set of RA radio resources, e.g., in frequency and subframes (time) for LTE, for each secondary cell or for a group of secondary cells. As illustrated in FIG. 17, the UE receives a configuration from the base station including one or more of these RA radio resources (step S60) and uses it/them to send a preamble on a secondary cell (step S62). If the UE sends a RA preamble on its primary cell, the UE uses the same RA radio resource(s) as a legacy UE would use on this Pcell (step S64). The base station can determine if a received RA preamble is from a UE sending an RA preamble on a secondary cell or on a primary cell based on which RA radio resource(s) the base station detects the RA preamble.

As already described above, the base station may configure each UE with a specific set of RA radio resources that the UE should use for a contention-free based random access on a Scell. The base station configures separate sets of RA radio resources on each secondary cell it operates. All UEs sharing the same primary cell and configured on a specific secondary cell are configured with the same set of RA radio resources on this specific secondary cell.

The technology described for the second embodiment offer a number of advantages: For example, a base station can provide a RA response message to a UE that sends a preamble on its secondary cell. In this way, similar to the fourth example embodiment, the base station need only address the correct cell/component carrier with the RA response message, which saves overhead for the random access procedure.

A further aspect of the present invention relates to random access transmit power levels. For example, the power control used for the transmission of a random access preamble on the RACH in LTE is open loop power control that is based on estimated pathloss and the received target power of the RA preamble to be received by the base station. The received target power is typically signaled to the UE as part of system information on the broadcast channel or via dedicated RRC signaling.

Since the random access preamble transmission is a non-scheduled transmission, it is not possible for the base station to employ a closed loop power control correction to correct for measurement errors in the open loop estimate. Instead, a power ramping approach is used where a UE initiating random access increases its transmission power (the RACH preamble received target power in LTE) between transmission attempts of the random access preamble. This ensures that even a UE with a too low initial transmission power, due to, e.g., error in the pathloss estimate, after a number of preamble transmission attempts, will have increased its power sufficiently to be detectable by the base station. For example, after 4 transmission attempts, the total ramp-up of the transmission power is: ΔPᵣₐₘₚᵤₚ(N-1)*Δ_{ramp step} where N is the number of transmission attempts and Δ_{ramp step} is the power ramping step size between each transmission attempt.

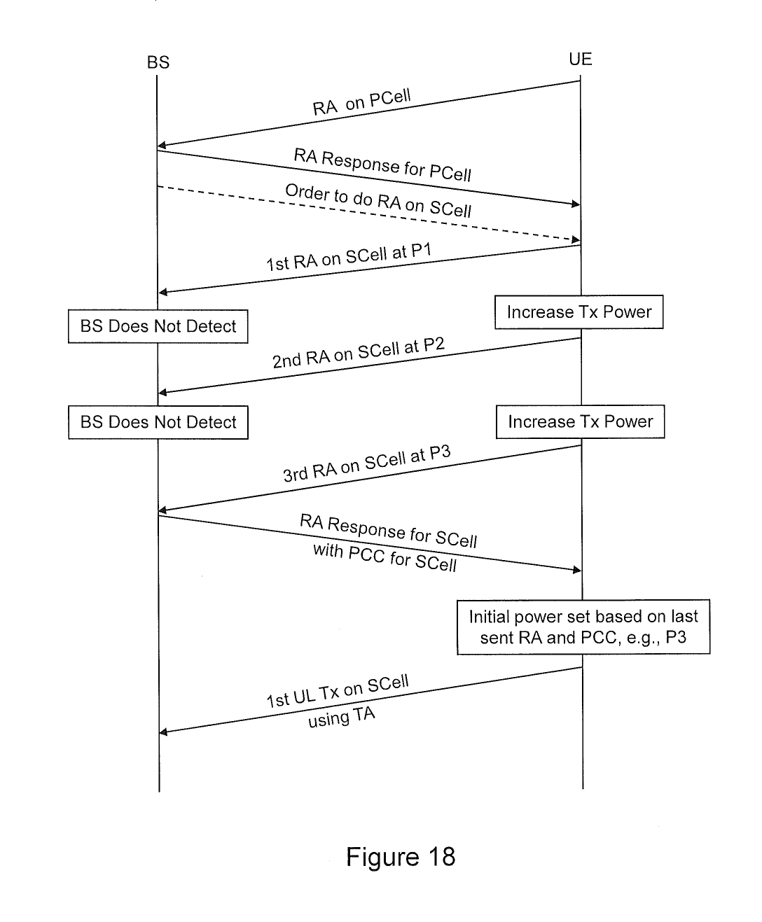

Setting that initial power level to zero (0) is a sub-optimal approach. Instead, better performance can be achieved if the initial transmit power for a UE RA request message sent over an Scell is set to a power level that is closer to the actually needed power. Reference is made to the signalling diagram shown in FIG. 18. The UE and base station exchange initial RA messages on and for the PCell. The UE then sends a RA request on an SCell at an initial transmit power level P1. The base station fails to detect that initial message, and after a time out period during which the UE fails to receive a RA response, the UE increases its transmit power to level P2 when it sends a second RA request on the SCell. The base station again fails to detect the second RA request message, and after a time out period, the UE increases its transmit power to level P3 when it sends a third RA request on the SCell. Now the base station detects the RA request and sends the RA response message with a power control command (PCC) in one example embodiment for future uplink transmissions by the UE on the SCell. The UE sets its initial power level based on the last sent RA request power level, e.g., P3 in this example, and/or on the received PCC. The UE then transmits uplink information on the SCell at the set initial power level.

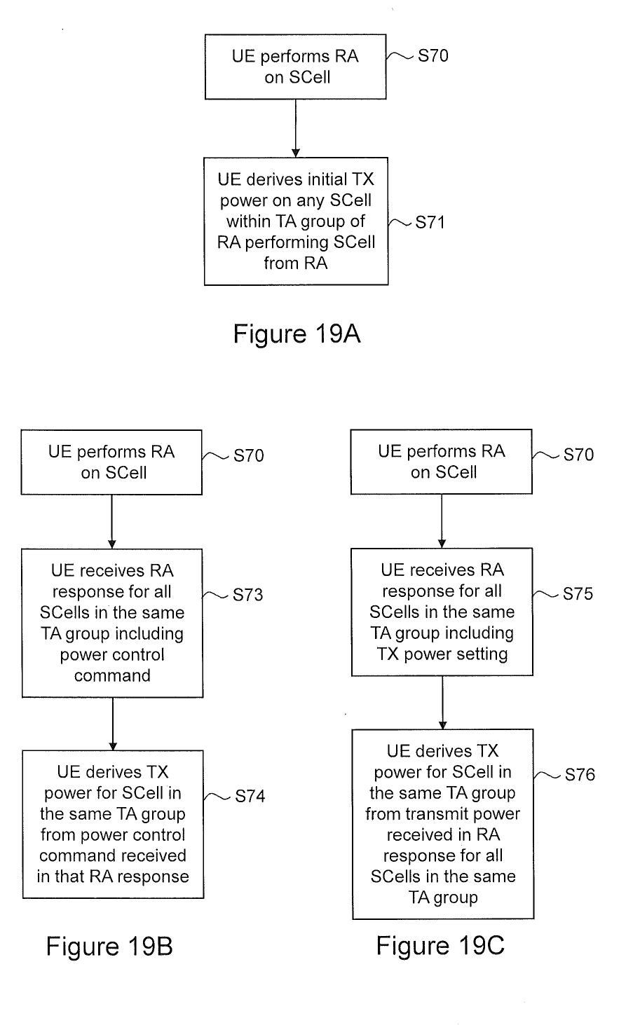

FIG. 19A-19C illustrate three example embodiments for the UE to determine the initial transmit power level after that the UE has performed RA on a SCell (step S70). According to one example embodiment (FIG. 19A), the UE determines the initial transmit power level for transmission on a secondary cell or a group of secondary cells connected to the same timing advance (TA) group based on the initial transmit power level set for the successful RA request (step S71). According to another example embodiment (FIG. 19B), the UE receives a RA response for a secondary cell or all secondary cells in the group of secondary cells connected to the same timing advance (TA) group or RA group, where that RA response includes a power control command (PCC) (step S73). The UE determines then an initial transmit power level based on the power control command (step S74). According to yet another example embodiment (FIG. 19C), the UE receives a RA response for a secondary cell or all secondary cells in the group of secondary cells connected to the same timing advance (TA) group or RA group, where that RA response includes a transmit power setting (step S75). The UE determines an initial transmit power level for an SCell in the same TA group from the transmit power setting received in the RA response (step S76). In other words, the UE applies for a newly-activated secondary cell the same initial transmit power or power spectral density as was received in the RA response for another serving cell belonging to the same TA group as the activated secondary cell and which performed a random access to obtain time alignment.

The RA response message may, according to one example embodiment, contain a power offset command relative to the primary cell that adjusts the transmit power of the UE's uplink transmission on the SCell with the SCell timing advance as compared to the transmit power used to send the preamble. According to another example embodiment, the RA response message may contain a transmit power command relative to the power used for the last transmitted preamble, which adjusts the transmit power of the UE's uplink transmission on the SCell with the SCell timing advance as compared to the transmit power used to send the preamble.

The power control command can also be corrected for different path losses of different frequency layers. This correction may be a signalled value, or the correction may be autonomously performed by the UE according to a suitable path loss model. The parameters of this model can either be coded in the standard or signalled by the network.

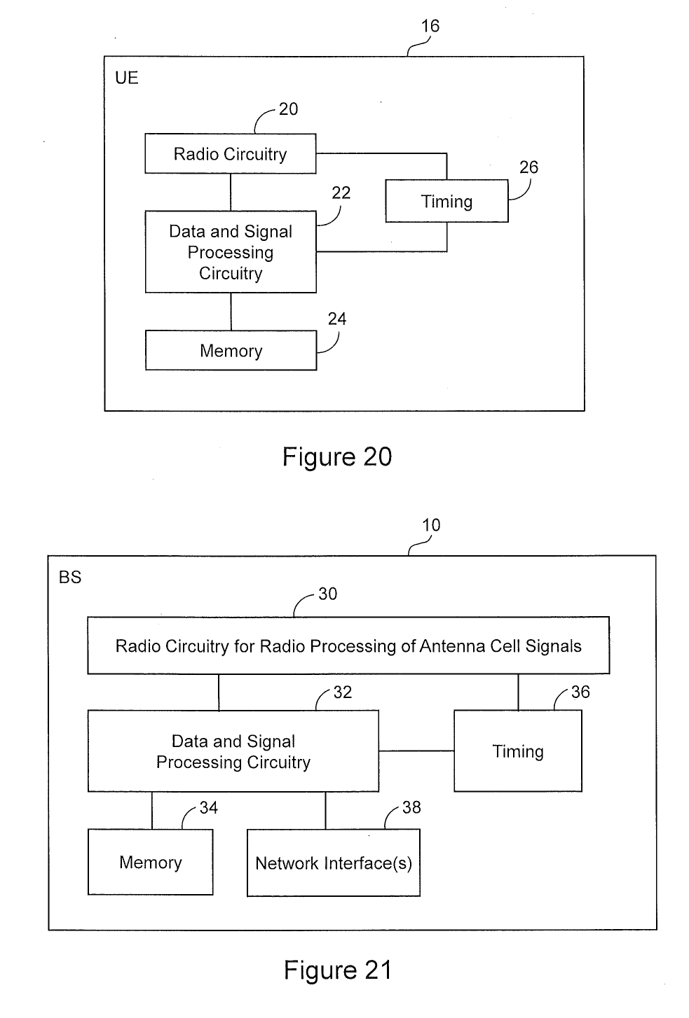

FIG. 20 is a non-limiting, example function block diagram of a UE 16 that may be used to implement the procedures described above for a UE. Such a user equipment may be a mobile radio telephone or a portable computing device with radio communication for example. The UE 16 may include, inter alia, radio circuitry 20, data and/or signal processing circuitry 22, and a computer-readable medium in the form of a memory 24. The memory 24 may be detachable from the UE. Timing circuitry 26 is connected to other UE entities that require timing signals and/or synchronization. One aspect of the timing circuitry is to provide timing advance signaling, e.g., under the control of circuitry 22, to a transmitter of the radio circuitry in order to send uplink transmissions at the proper advance time so they are received in a synchronized fashion at the base station. Circuitry 22 also may be used to set the desired initial transmit power level of RA preambles and/or initial uplink transmissions using the TA received as part of the RA procedure. In one example embodiment, the memory 24 stores a computer program with computer program instructions, which when run by a processor, causes the UE to perform all or some of the steps described above.

FIG. 21 is a non-limiting, example function block diagram of a base station (BS) 10 that may be used to implement the procedures described above for the base station. Radio circuitry 30 performs radio processing of PCell and SCell signals. Data and/or signal processing circuitry 32 controls the radio circuitry, timing circuitry 36, memory 34, and one or more network interfaces 38. For example, the data and/or signal processing circuitry 32 provides the content of the random access response messages described above including but not limited to the timing advance and cell identifier information.

The memory of the UE and/or base station may for example be a flash memory, a RAM (Random-access memory) ROM (Read-Only Memory) or an EEPROM (Electrically Erasable Programmable ROM), and the computer program instructions may in alternative embodiments be distributed on additional memories (not shown). A data processor may not only be a single CPU (Central processing unit), but could comprise two or more processing units. For example, the processor may include general purpose microprocessors, instruction set processors and/or related chips sets and/or special purpose microprocessors such as ASICs (Application Specific Integrated Circuit).

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology described, for it to be encompassed by the present claims.

1. A method in a user equipment, UE, communicating with a radio base station on a primary cell associated with a first frequency and at least one secondary cell associated with a second frequency different from the first frequency, the method comprising:
transmitting a preamble on a random access channel, RACH, to the radio base station on the secondary cell;
receiving a random access response message from the radio base station on a different cell than the UE transmitted its preamble on, said random access response message including timing advance information for an uplink transmission by the UE and including a cell identifier to determine the secondary cell that the control information in the random access response message refers to; and
transmitting to the radio base station based on the timing advance information in the random access response message.

2. The method according to claim 1, wherein the UE transmits to the radio base station, based on the timing advance information in the random access response message, on the secondary cell on which the preamble was sent.

3. The method according to claim 1, wherein the cell identifier of the secondary cell is a cell index and wherein the cell index is one of a SCellIndex, ServCellIndex, or Carrier Indicator Field CIF.

4. The method according to claim 1, wherein the cell identifier of the secondary cell is an EARCFN value or an index which corresponds to a subset of EARCFN values.

5. The method according to claim 1, wherein the cell identifier of the secondary cell is a Random Access-Radio Network Temporary Identifier (RA-RNTI) which scrambles a check CRC of a PDCCH scheduling random access response message,

6. The method according to claim 1, wherein the UE receives further comprising receiving a PDCCH message indicating a scheduled uplink message, MSG3, only in common search space in the same cell as it received the random access response message, and
wherein the scheduled uplink message indicated by the PDCCH message is identified by that the CRC of the correspond PDCCH is scrambled by the Temporary Cell-Radio Network Temporary Identifier (TC-RNTI).

7. The method according to claim 1, wherein the UE transmits the preamble within a set of preambles for contention-based random access on the secondary cell.

8. The method according to claim 7, wherein the preamble is within the set of preambles that are used for contention-free random access.

9. The method according to claim 1, further comprising:
receiving from the radio base station a separate set of PRACH resources for random access on the one or more secondary cells, wherein the PRACH resources are separated in frequency and/or subframes, and
transmitting a random access request to the secondary cell using at least one preamble in the separate PRACH resource set.

10. The method according to claim 1, whereby the UE transmits to the radio base station on a cell within a group of the one or more secondary cells that is defined to be in the same timing advance group and applying a transmit power level that is set in response to power used to transmit the preamble.

11. The method according to claim 10, wherein the UE receives the random access response message containing an initial power control command and applies the initial power control command for the secondary cell on which the preamble was sent to a cell within the group of the one or more secondary cells that is defined to be in the same timing alignment group.

12. The method according to claim 11, wherein the UE applies the initial power control command in the random access response message relative to the power on the primary cell.

13. The method according to claim 11, wherein the UE applies the initial power control command in the random access response message relative to the power used for the last transmitted preamble.

14. The method according to claim 11, wherein the UE autonomously corrects the initial power control command for different pathloss on the different cells.

15. The method according to claim 11, wherein the UE uses a signaled value to determine a correction of the initial power control command for different pathloss on the different cells.

16. A method in a radio user equipment, UE, communicating with a radio base station on a primary cell associated with a first frequency and at least one secondary cell associated with a second frequency different from the first frequency, the method comprising:
transmitting a preamble on a random access channel, RACH, to the radio base station on the secondary cell;
performing blind decoding operations for the secondary cell on a downlink control channel search space for said secondary cell on which the preamble was sent;
detecting a random access response message from the radio base station, said random access response message including timing advance information for an uplink transmission by the UE;
transmitting to the radio base station on the secondary cell on which the preamble was sent based on the timing advance information in the random access response message.

17. The method according to claim 16, wherein the UE reallocates a portion of its blind decodes from a UE specific search space to a downlink control channel search space for the secondary cell on which the preamble was sent.

18. The method according to claim 17, wherein the UE specific search space is associated with the secondary cell on which the preamble was transmitted.

19. The method according to claim 16, further comprising performing the transmitting of the preamble on the RACH and detecting the random access response message by a contention-free random access procedure.

20. The method according to claim 16, further comprising performing the transmitting of the preamble on the RACH and detecting the random access response message by a contention-based random access procedure.

21. The method according to claim 16, wherein the downlink control channel search space that the UE monitors is a downlink control common search space.

22. The method according to claim 16, whereby the UE transmits to the radio base station on a group of the one or more secondary cells that is defined to be in the same timing alignment group and applying a transmit power level that is set in response to power used to transmit the preamble.

23. The method according to claim 22, wherein the UE receives a random access response message containing an initial power control command and applies the initial power control command for the secondary cell on which the preamble was sent based or the group of the one or more secondary cells that is defined to be in the same timing alignment group.

24. The method according to claim 23, wherein the UE applies the initial power control command in the random access response message relative to the power on the primary cell.

25. The method according to claim 23, wherein the UE applies the initial power control command in the random access response message relative to the power used for the last transmitted preamble.

26. The method according to claim 22, wherein the UE autonomously corrects the initial power control command for different pathloss on the different cells.

27. The method according to claim 22, wherein the UE applies a signaled value that corrects the initial power control command for different pathloss on the different cells.

28. A method in radio base station operating a plurality of cells and communicating with user equipments, UEs, on primary cells associated with a first frequency and at least one secondary cell associated with a second frequency, the method comprising:
configuring the UEs with specific sets of random access preambles such that UEs sharing a same primary cell and configured on a specific secondary cell are configured with the same set of random access preambles on this secondary cell;
providing information on said specific sets of random access preambles to the UEs;
detecting a preamble on RACH from a first one of the UEs on the secondary cell;
transmitting a random access response from the radio base station on a different cell than the first UE transmitted its preamble on, said random access response including timing advance information for an uplink transmission by the first UE and including a cell identifier to determine the secondary cell that the control information in the random access response message refers to.

29. The method according to claim 28, wherein the radio base station reserves a set of random access preambles for UEs that are limited to perform random access on the primary cell.

30. The method according to claim 28, wherein the radio base station provides information on specific sets of random access preambles to the UEs by transmitting root sequences from which the UEs generate the reserved preambles.

31. A user equipment, UE, comprising a radio circuitry for communicating with a radio base station on a primary cell associated with a first frequency and at least one secondary cell associated with a second frequency different from the first frequency, the UE adapted to
transmit a preamble on a random access channel, RACH, to the radio base station on the secondary cell;
receive a random access response from the radio base station on a different cell than the UE transmitted its preamble on, said random access response including timing advance information for an uplink transmission by the UE and including a cell identifier to determine the secondary cell that the control information in the random access response message refers to; and
transmit to the base station based on the timing advance information in the random access response message.

32. A user equipment, UE, comprising a radio circuitry for communicating with a radio base station on a primary cell associated with a first frequency and at least one secondary cell associated with a second frequency different from the first frequency, the user equipment adapted to:
transmit a preamble on a random access channel, RACH, to the radio base station on the secondary cell;
perform blind decoding operations for the secondary cell on a downlink control channel search space for said secondary cell on which the preamble was sent;
detect the random access response message from the base station, said random access response including timing advance information for an uplink transmission by the UE; and
transmit to the base station on the secondary cell on which the preamble was sent based on the timing advance information in the random access response message.

33. A radio base station comprising a radio circuitry for operating a plurality of cells and communicating with user equipments, UE, on primary cells associated with a first frequency and at least one secondary cell associated with a second frequency, the radio base station adapted to:
configure the user equipments with specific sets of random access preambles such that user equipments sharing a same primary cell and configured on a specific secondary cell are configured with the same set of random access preambles on this secondary cell;
provide information on said specific sets of random access preambles to the user equipments;
detect a preamble on RACH from the user equipment on the secondary cell; and
transmit a random access response from the radio base station on a different cell than the UE transmitted its preamble on, said random access response including timing advance information for an uplink transmission by the UE and including a cell identifier to determine the secondary cell that the control information in the random access response message refers to.
